(19) United States
(12) Patent Application Publication
(10) Pub. No.: US 2012/0072837 A1
(43) Pub. Date: Mar. 22, 2012

(54) METHOD, SYSTEM, APPARATUS, AND PROGRAM FOR ON DEMAND DOCUMENT DELIVERY AND EXECUTION

(76) Inventor: C. Richard Triola, Laguna Beach, CA (US)

(21) Appl. No.: 13/104,972

(22) Filed: May 10, 2011

Related U.S. Application Data
(60) Provisional application No. 61/332,953, filed on May 10, 2010.

(51) Int. Cl. G06F 17/24

(52) U.S. Cl. 715/268

(57) ABSTRACT

Methods, systems, apparatuses, and programs for implementing, managing, and tracking on-line digital transactions via electronic and digital submissions/documents for legal execution of contracts between parties via a medium such as the Internet. Multiple access methods are employed. A computerization and internet type process implementation is provided for processes including, but not limited to, digital transaction coordination, digital status coordinators, seamless transactions, on-line digital signatures, video and audio signature authentication, digital transaction recording and storage, digital certificate authentication, signature authentication, satellite, and other wireless transmission of transactions, voice digital instruction, the merging of voice with digital data transactions, set-top/WebTV digital transmission, global digital networking, and the like. The system includes appropriate data, application, and servers along with supporting LAN or WAN-based applications to perform the services.

### CROSS REFERENCE TO RELATED APPLICATION

This application claims the benefit of U.S. Provisional Application No. 61/322/953, filed May, 10, 2010.

### BACKGROUND OF THE INVENTION

1. Field of the Invention

The present invention generally relates to document execution and delivery, and more particularly to a method, system, apparatus, and program for implementing, managing, and tracking on-line digital transactions via an electronic and digital submission document for legal execution of contracts between parties via a medium such as the Internet.

2. Related Art

In the main, the use of actual purchase agreements, third party services, and associated contracts, such as sales agreements, confidentiality agreements, etc., are handled manually since the true identity of the principals and their agreement by signature on the assorted contracts and documents involved is a critical, personal factor. Authentication/Notarization on more important documents is often required. The coordination of the various entities, such as couriers, overnight delivery services, postal service, and the like involved with the transfer of paper based wet-signed documents, is assigned to licensed or non-licensed agents. In turn, the agent usually must involve the aid of administrative assistants to track all of the required paperwork and transfer of funds necessary to complete the transaction. As can be imagined, the number of such transactions in a single location (e.g., a California county) on a daily basis is enormous.

Many documents/transactions are processed today in paper using conventional delivery means, US Postal services, FedEx, UPS, DHL, courier services, and the like which require so-called “Submitters” to spend a considerable amount of time and effort to prepare the document(s) for delivery, deliver the documents to a ‘drop-off’ point/box, or have someone pick up the envelope for delivery. The burden then rests with the carrier to jump through often tremendous hoops to deliver that envelope to the proper person and then the “Recipient” is handed the burden to sign the document(s) and return them via the same process as the original submitter. Typically, from coast to coast in the U.S., this process takes a couple of days to complete.

### SUMMARY OF THE INVENTION

There exists, therefore, a need to accomplish such cumbersome tasks much more quickly without all the familiar delays and challenges caused by the mishandling of packages, bad weather, human intervention, delayed flights, and the like. The present invention can overcome such drawbacks, and can accomplish such tasks, in some cases, in minutes.

Notably, the systems and methods of the present invention can be entirely automated to provide a portal enabling document delivery and execution that is quickly and easily accessible even to parties who are not previously registered.

In Applicant's view, with the establishment of the Internet, the world wide web, and the like, the emergence of e-commerce has generated a need for a computerized method and apparatus for processing escrow transactions, and a method of managing escrows using such tools.

In the main, according to one embodiment of the present invention, a portal serves as an intermediary to allow on-demand submitting parties (including clients or non-clients) to submit documents to Recipient(s) for the purpose of legally accepting, authenticating, and executing/closing documents/transactions by affixing a legally binding electronic signature(s) to any/all correspondence/documentation An agreement, document, or any type, is delivered through the Portal to be delivered directly by the Submitter to the Recipient (referred to as ‘Principals’) only upon the fulfillment of all the conditions precedent which are imposed upon the principals, and are usually of the express terms and conditions of a purchase and sale agreement (also referred to more simply as a “sales contract” hereinafter), not limited in scope.

For the purpose of describing the present invention, an exemplary digital transaction for signature is considered; no limitation on the scope of the invention is intended by the inventor nor should any be implied therefrom.

The present invention according to an embodiment provides implementing, managing, and tracking of on-line digital transactions via an on demand portal upload, including instructions, automatic payments, opening, settlement, servicing, real-time or near-real time status of the parties, including but not limited to vendors, buyer and seller, sender, recipient, and closing/settlement of a transaction via a medium such as the internet. Multiple access methods are employed. The present invention provides computerization and internet type process implementation.

The system and method of operation of the present invention include the use of computerized devices and telecommunications devices connected to the Internet (or the like) which are adapted to perform one or more of:
receiving instructions for the opening of a transaction;
providing and sending digital instructions to all parties involved in the transaction;
offering the availability of a continuous digital reporting/monitoring transaction by coordinating and permitting access to the on-going status of a transaction in progress;
on-line digital signature, voice, video fingerprint or retina scanning personal identification authentication, digital audio, visual, and video recording of transaction;
transfer of funds via electronic and/or scanning means or other consideration;
submission of original and/or supporting documents;
closing and/or execution of transaction, delivery of acceptance notices and final executed transaction/documents or clear title, and release of transaction funds;
and the like as would be useful in an online digital transaction or a paper-based transaction.

The apparatus and method according to an embodiment of the present invention implements, manages, and tracks on-line digital transactions via a medium such as the Internet including opening, servicing, real-time or near-real time status of all parties (the transaction submitter, recipient, vendor, buyer, and seller), and closing of a transaction. Multiple access methods are employed. The present invention provides digital computerization, video recording and internet type process implementation for digital transactions including, but not limited to:

digital transaction coordination,

digital vendor service transaction coordination;

digital status coordination and communication;

seamless digital transactions;

party and third party personal identification authentication, such as on-line digital signature, thumb-print, retinal scan, biometrics, video signature authentication, digital certificate authentication, and the like (generically referred to hereinafter as identification authentication; no limitation on the scope of the invention is intended by this list nor should any be implied), transmission of digital instructions, and voice digital instructions, the merging of voice with transactions, wireless transactions, set-top/webTV digital transactions, global digital networking, including appropriate data, application, and servers along with supporting LAN or WAN-based application to perform digital and legal transaction execution services, and the like. Accordingly, the present invention provides in one embodiment an essentially completely computerized and networked system for any type of digital electronic transaction.

The present invention in an embodiment provides a method and apparatus for independent transaction facilitation, providing on-line digital enforcement and delivery services.

The present invention in another embodiment provides a software system for offering secure accounts for the submission and receipt of legally binding (depending on the jurisdiction) document execution, workflow, and for business-to-business transactions using such vehicles as the Internet, world wide web, wireless telecommunications, and the like.

The present invention provides a method and apparatus for digital document transactions.

The present invention provides an Internet- (or the like) based automation system that provides for implementing, managing, and tracking digital document transactions which will be accessible for specific parties to a particular transaction.

The present invention includes security measures for digital document transactions.

For verification of credentials, the present invention in one aspect authenticates users and validates the credentials of the user through private key encryption, a process which identifies valid transactions by verifying the encrypted key (digital certificate) used to sign a document. This signature key is validated with private keys held by the document recipient—and master keys held by trusted third parties. Invalid keys (signatures) are instantly identified—thereby providing a level of fraud protection not available with legacy manual systems.

The present invention provides for a web browser (or the like) for opening, processing, and closing of personal property such as proprietary documents via on-line entry of instructions, and further including remote printing of documents for party signatures or some other method of electronic signature, ordering all of document delivery services to appropriate recipients, service providers, accepting status updates for submitters, recipients, service providers and/or seller and/or buyer, viewing item status and activity associated with each document performance item, processing and tracking of all fund transfers through all processes, and final closing of the transaction.

The present invention provides a method and apparatus for safe and secure harbor of personal property, digital document delivery, and business-to-business transactions over vehicles such as the internet and wireless communications.

The present invention provides a method and apparatus for computerized digital transactions including permission based rules and status and the transaction servers coupled using multiple access such as internet, intranet, extranet, via all connectivity types which include but are not limited to wireless, satellite, dial-up, or leased communications.

The present invention provides a system for real-time or near-real-time execution of transactions including appropriate data, application, and web servers along with supporting network based applications to perform at least one of the following for authorized parties to such transaction:
receive/store instructions upon submission by a party to the recipient (or their agent) via a computerized communications device;
disseminating instructions to all relevant parties by electronic means, fax, or physical delivery, including preference determination;
providing documentation electronically;
providing documentation approval;
automating order specified services through electronic means;
real-time and near-real-time display of instructions, status, and activity;
providing for electronic personal identification authentication;
closing legally binding transactions;
release of required funds, automatic payments via credit card, ACH, etc.; and
digital transfer of funds.

In a basic aspect according to an example embodiment, the present invention provides an apparatus for personal and business to business transactions, including: a computer based automation system, having components providing implementation, management, and tracking of transactions, wherein data for implementing, managing, and tracking the transactions is accessible for specific parties to said transactions.

In another aspect, the present invention provides a client-server computer system for submission of property, including: at least one client module associated with at least one client party for initiating a transaction process with at least one party; and at least one server module associated with the submitting party, wherein a specific account between said client party and said submitting party is established, maintained, tracked, and consummated via said client-server computer system.

In yet another aspect, the present invention provides a process for a computerized transaction including: providing submitting and recipients account status for all parties to the transaction and notification and status to non-signers via a centralized server associated with a submitting party, and connecting parties to said computerized transaction using multiple computer network access devices via connectivity types which include but are not limited to wireless, satellite, dial-up, or leased communications.

In another aspect, the present invention provides a system for real-time or near-real-time digital transactions, including: appropriate data, application, and transactional management programs; and supporting network based applications to perform at least one of the services selected from a group including: receiving and storing instructions upon submission by a party to the transaction via a computerized communications device; disseminating instructions to all relevant parties by computer; providing documentation; providing documentation approvals; automating order specified services; real-time and near-real-time display of instructions, status, and activity; on-line digital identification authentication; transfer of ownership; legal execution of transaction closing such transaction; releasing of funds; and digital transfer of funds.

In a further aspect, the present invention provides a method of doing business using an internet including: providing an on-line account for parties to a transaction; providing on-line transactional account management services with respect to the on-line account for said parties; and providing secure access to said on-line account limited to the parties and third parties using on-line identification authentication.

In another aspect, the present invention provides a computer memory including: program code providing a client-server based automation system for a digital document transaction; program code providing implementation, management, tracking, and closing of specific transactions; and program code allowing transaction data access only for specific parties to said transaction.

The foregoing summary is not intended to be an inclusive list of all the aspects, objects, advantages, and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Objectives, features and advantages of the present invention will become apparent upon consideration of the following explanation and the accompanying drawings, in which like reference designations represent like features throughout the drawings.

### BRIEF DESCRIPTION OF THE DRAWINGS

The features and advantages of the present invention will be more readily understood from a detailed description of the exemplary embodiments taken in conjunction with the following figures:

FIG. 1 shows an example aspect of the present invention using the Internet, wherein the invention is implemented on an on-demand portal.

FIG. 2, which includes FIGS. 2A and 2B, shows a method of operation of the present invention according to an example aspect, in particular using a portal such as the portal shown in FIG. 1.

FIG. 3 shows a method of operation of the present invention according to another example aspect.

FIGS. 4 and 5 are screen shots showing example aspects of the present invention.

FIG. 6 shows an example of a computer system equipped to carry out the functions of the present invention.

FIGS. 7-24 are further screen shots showing example aspects of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

The present invention relates generally to document execution and delivery, and more particularly to methods, systems, apparatuses, and programs for processing digital execution/signing transactions, and a method of doing business in electronic, digital, and paperless transactions using computers and computer network technology. More particularly, the present invention relates to a computerized method and apparatus for electronic, digital, and paperless transactions and a method of doing business in digital document transaction management, preferably using the Internet.

The apparatus and method according to an embodiment implements, manages, and tracks on-line digital transactions via an electronic medium, including opening, servicing, real-time or near-real time status of all parties to the transaction and closing of said transaction via a medium such as the Internet. Multiple access methods are employed. The present invention provides digital computerization and internet type process implementation for transaction including, but not limited to:

transaction coordination,

vendor service transaction coordination,

status coordination and communication,

seamless transactions,

party and third party personal identification authentication, such as on-line digital signature, thumb-print, retinal scan, video signature authentication, audio and visual authentication, recording and storage, digital certificate authentication, and the like (generically referred to hereinafter as identification authentication; no limitation on the scope of the invention is intended by this list nor should any be implied), transmission of digital instructions, and voice digital instructions, the merging of voice with transactions, wireless transactions, set-top/webTV transactions, global digital networking, including appropriate data, application, and servers along with supporting LAN or WAN-based application to perform services, and the like. In other words, the present invention in one embodiment provides a completely computerized and networked system for any type of document execution transmission transaction.

Reference is made now in detail to specific embodiments of the present invention which illustrate preferred embodiments for practicing the invention. Alternative embodiments are also briefly described as applicable.

As an example transaction to describe an example aspect of the present invention, a submitting party or Submitter desires to have an agreement/contract signed and must do so immediately but does not have an account with a system/vendor. The submitting party enters the system, provides instructions, pays for service, and uploads document(s) to be routed to the recipient(s). The Recipient receives and opens a message or e-mail containing document(s) sent by Submitter, Recipient authenticates identity, reviews, and electronically signs the document(s) and automatically returns them to Submitter. All parties to the transaction, including non-signers, can then receive confirmation of completion notice and copies of the originally signed document(s). This example is only used to simplify the detailed description of the present invention; no limitation on the scope of the invention is intended nor should any be implied.

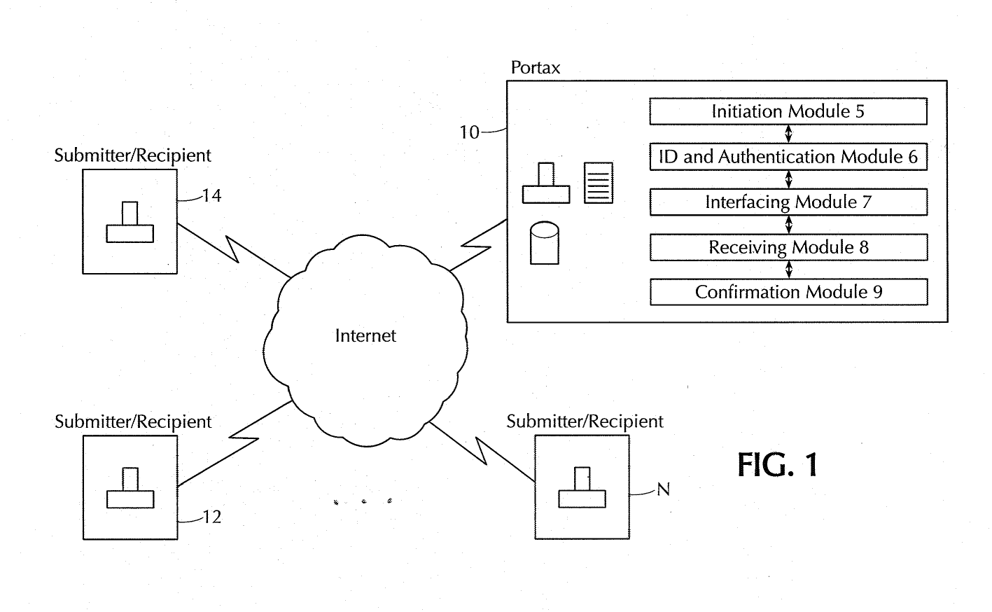

FIG. 1 shows an example aspect of the invention using the Internet, wherein the invention is implemented on an on-demand website or portal 10 including a server or web server that hosts the website. The on-demand portal 10 can communicate through the Internet with a number of end users having terminals 12, 14, . . . N, who may act as Submitters and/or Recipients. The portal 10 can run and support network-based applications including software routines and computer modules to perform at least some of the functions of the present invention. (For the sake of simplicity, Internet Service Providers, routers, firewalls, and the like that are well known in the art are not shown.)

The Submitters/Recipients can access the portal through their own personal computing system or terminal, which may be a lap top, a desk top, a mobile device, etc., including, for example, a keyboard, a mouse, a touch screen, a trackball, and/or any other suitable type of user-operable input device(s). The output user interface may include, for example, a video display, a liquid crystal or other flat panel display, a speaker, and/or any other suitable type of output device for enabling a user to perceive outputted information. Such mobile device could include beepers/pagers, such as Blackberry pagers, that have visual and interactive capabilities, along with a means of downloading or uploading content (for example, over the air or attached to a computer); another example is a PDA (Personal Digital Assistant) such as a PalmPilot, SmartPhone, or PocketPC.

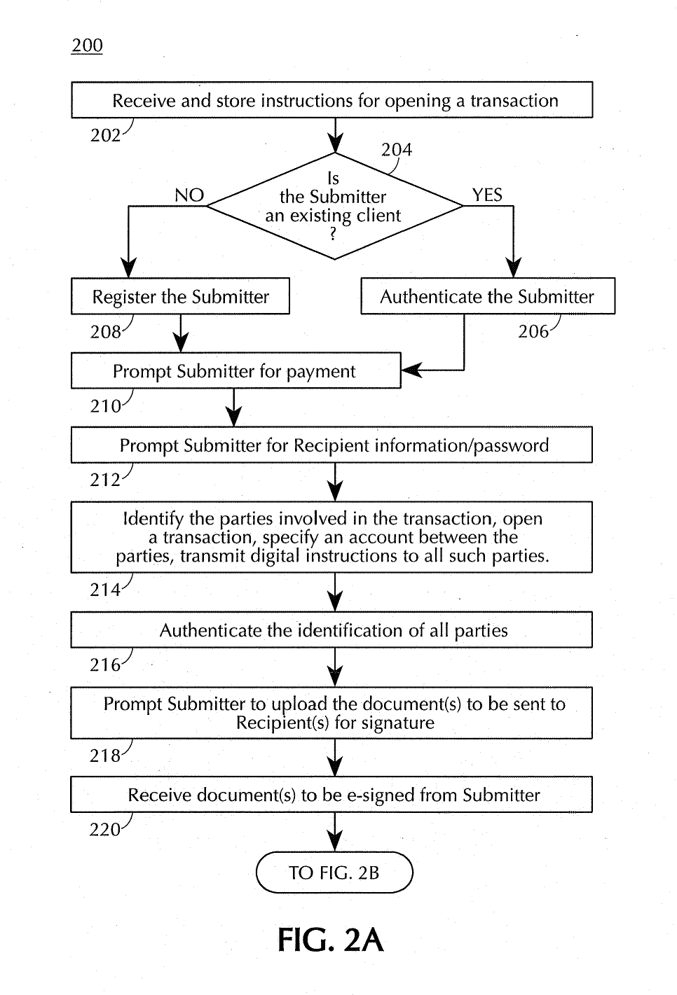

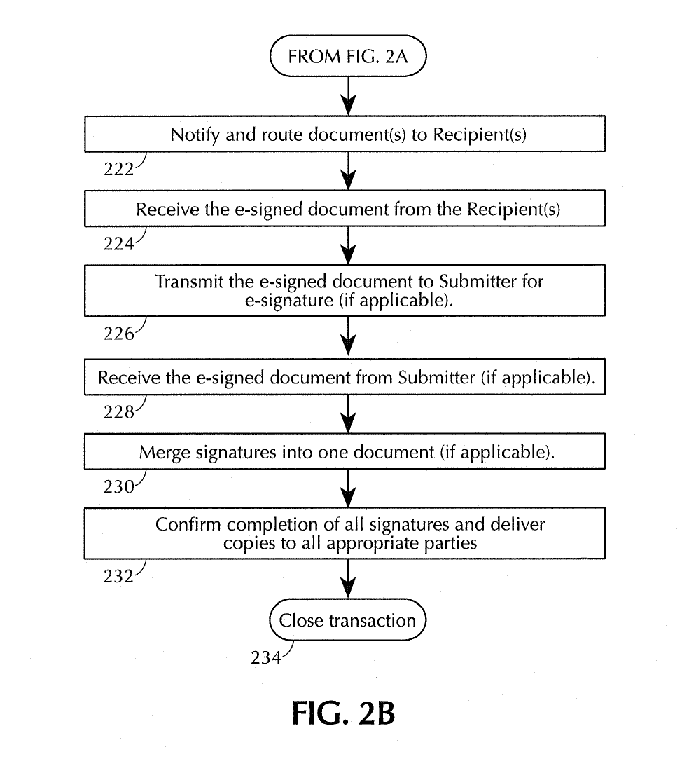

FIG. 2 (which includes FIGS. 2A and 2B) shows a method 200 of operation of the present invention according to an example aspect, in particular using the portal 16 shown in FIG. 1. It is of course to be understood that this is only an example (and is not meant to be all encompassing) of steps that may be included in the method. The order of the steps is merely an example as well.

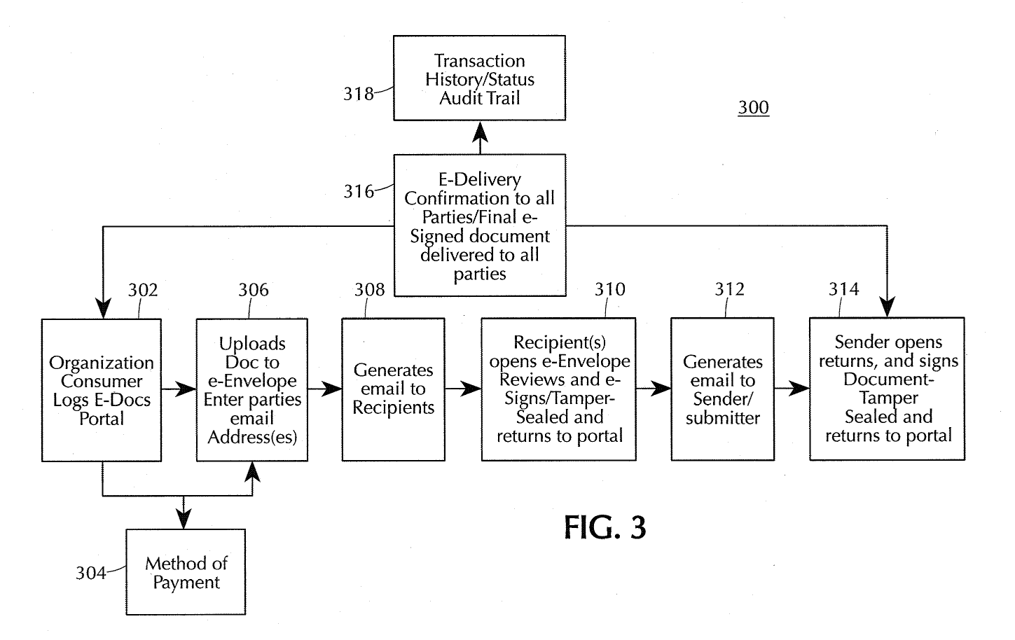

The method shown in FIG. 2 (and the other methods and systems set forth herein, including the method shown in FIG. 3) can be entirely automated to provide a portal enabling document delivery and execution that is quickly and easily accessible even to parties who are not registered. Accordingly, delays in start-up time can be greatly reduced, as the system enables parties to quickly access and use the virtual or e-signing room/portal of the present invention without having a previous relationship/contract with the provider of the portal, without having to be pre-approved by the provider of the portal, and without having any previous setup with the portal. This can result in a document or contract being executed by all parties within minutes. The present invention is believed to be the first automated global e-signing portal available anywhere.

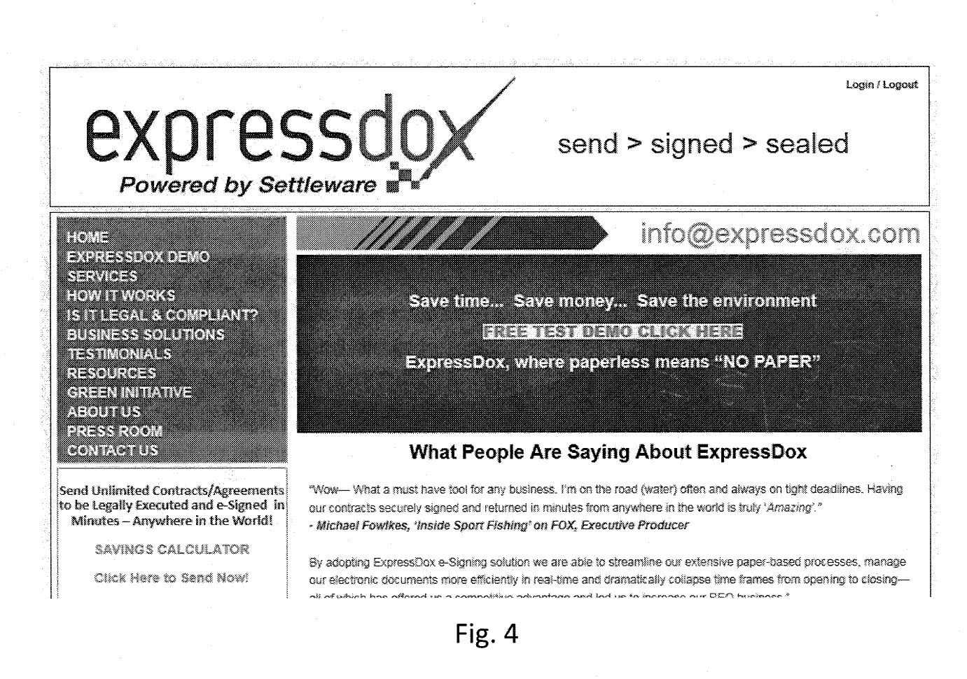

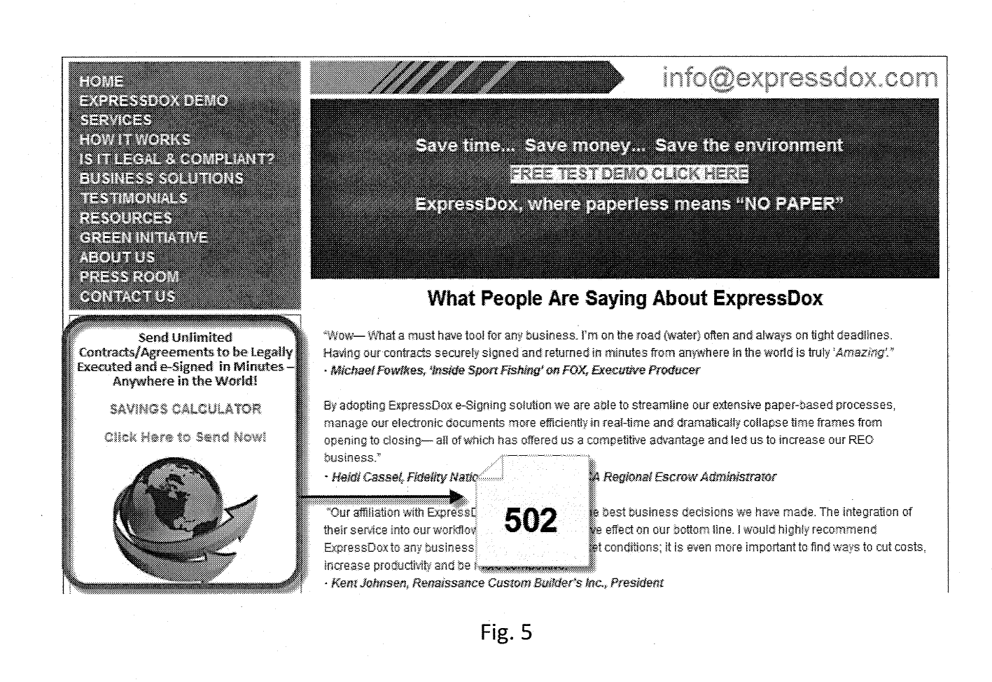

In step 202 instructions for opening a transaction are received and stored by the portal 10. This can be initiated for example when the Submitter 12 accesses the portal 10 to enter the system (see, e.g., the screen shot in FIG. 4 as an example of what the Submitter 12 may see on his web browser), and the Submitter 12 clicks on the prompt for opening a transaction or for sending a document to a Recipient 14 (see the screen shot in FIG. 5 as an example, box 502).

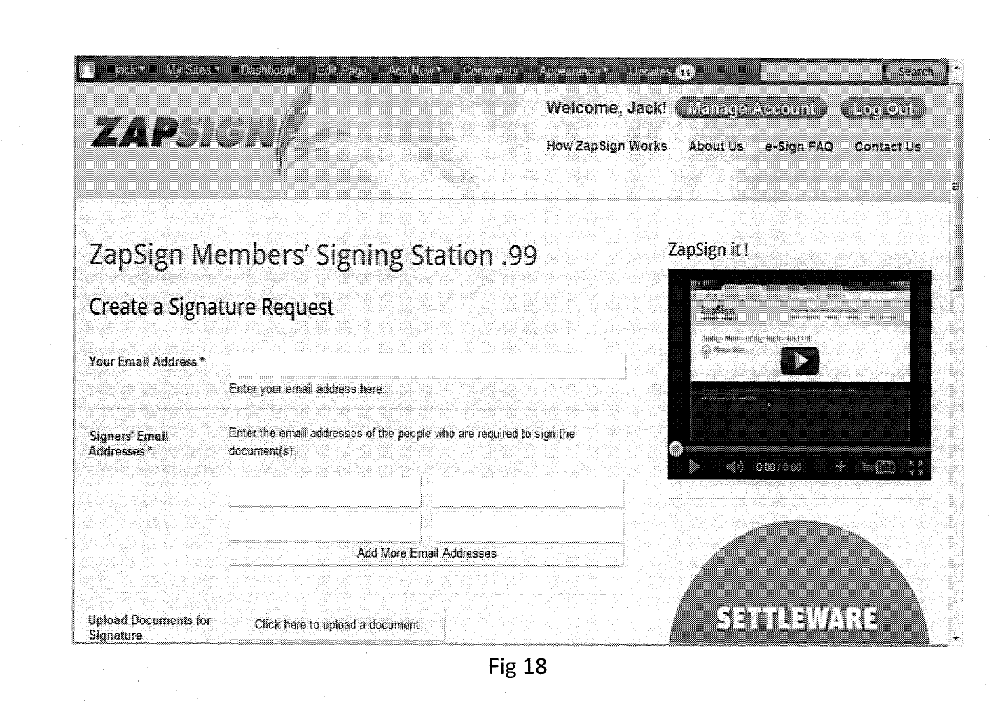

In step 204 the portal 10 checks whether the Submitter 12 is an existing client. If so, in step 206, the portal proceeds to authenticate the Submitter 12. If not, in step 208, the portal 10 proceeds to register the Submitter 12. Registration can be automatically performed quickly and easily, even if the Submitter 12 doesn't have an account with the provider of the portal 10, by prompting the Submitter 12 to fill out a secure electronic signing request form. FIG. 18 shows an example of this form, which enables the Submitter 12 to create a signature request. The signature request form prompts the Submitter 12 for a File Name to call the signature request or transaction, along with the Submitter's name and e-mail address.

No confirmation of the information filled out by the Submitter 12 on the signature request form need be performed. No credit check need be performed. No account for the Submitter 12 or any of the other parties need be created (although of course one can be). The present invention can handle a first user or first users of the portal and quickly effect e-signature by the parties in very little time, using just the information supplied by the parties.

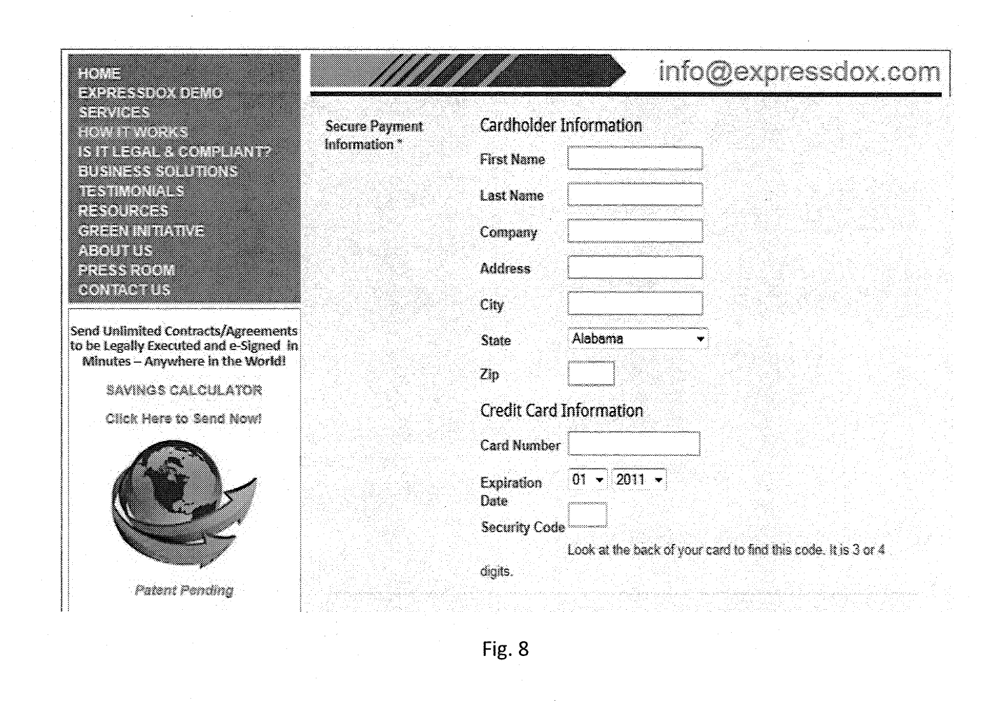

In step 210 the portal 10 prompts the Submitter 12 for payment (e.g., credit card information) in exchange for accessing the services provided by the portal 10, so that the transaction can be paid for. See, e.g., the screen shots of FIG. 8 and FIG. 18 in which the Submitter 12 is prompted for his or her cardholder information so that secure payment can be effected.

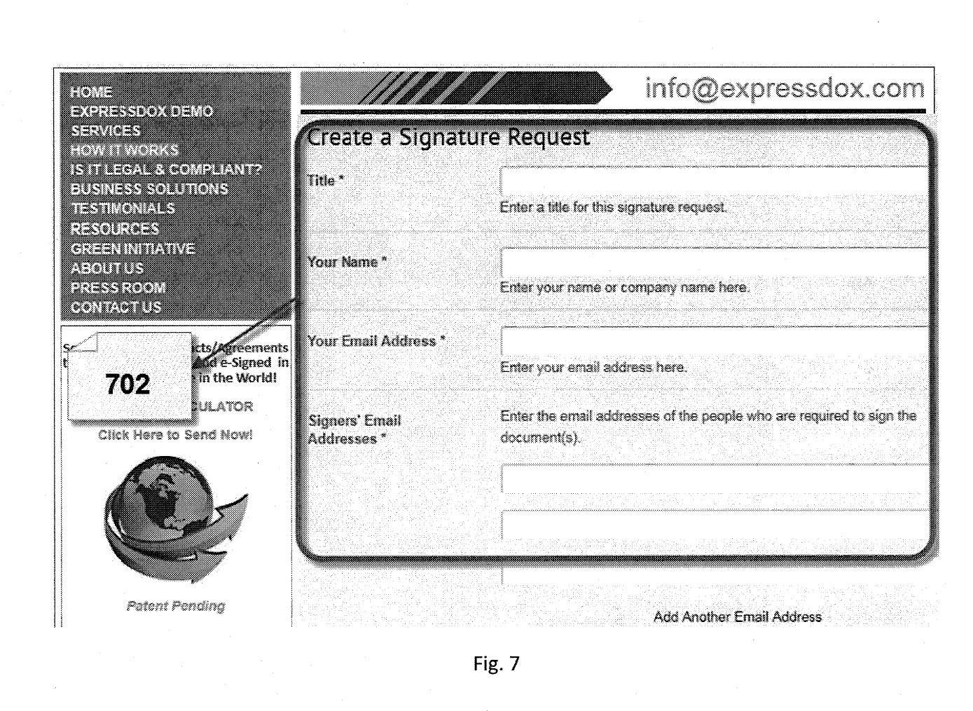

In step 212 the Submitter 12 is prompted for the Recipient 14 information and can assign a password to the Recipient 14 or a third party for ID verification via telepresence, webcam, retina scan, etc. See, e.g., the screen shot of FIG. 7 (box 702) which shows that the Submitter 12 is prompted for the name of the Recipient 14, the e-mail addresses of the Recipient(s) and any non-signers, a file password if desired, and optional email text (e.g., greeting message and/or instructions). See also, as another example, the screen shot of FIG. 18, in which the signature request form is shown to prompt the Submitter 12 for the email addresses of all of the people who are required to sign the document(s), as well as the email addresses of any people who will not be signing the document but who should receive copies of the signed document. The Submitter 12 is also be afforded the opportunity to send a message to the people who will be receiving the document. Steps 202-212 (and steps 218-220) can be performed, for example, by the initiation module 5 shown in FIG. 1.

In step 214 the portal 10 identifies the parties involved in the transaction from the information filled out by the Submitter 12 in step 212, opens a transaction, specifies an account between the parties, and transmits digital instructions to all such parties. The instructions could be in the form of any or all of text, voice, video, etc. Instructions can be sent electronically, by fax, by physical delivery, etc. Accordingly, the portal 10 can send e-mail messages to the other parties who need to sign the document or who should be cc'd. The e-mail messages in one embodiment contain links to an online e-signing room.

In step 216 the identification of all parties is authenticated. This can occur in a number of ways, including but not limited to on-line digital signature, thumb-print, voice, video fingerprint, retinal scan, video signature authentication, video recording of transactions, digital certificate authentication, etc. Steps 214-216 can be performed, e.g., by the identification and authentication module 6 of FIG. 1.

In step 218 the Submitter 12 is prompted to upload the document(s) to be routed to the Recipient(s) 14 for electronic or e-signature. All document types can be accommodated, for example Word, Wordperfect, Excel, pdf, etc. See, for example, the screen shot of FIG. 18.

Parties (Submitters/Receivers/vendors) can upload document(s) via the portal 10 and/or mobile PDA, or any other suitable process (such as set top device, etc.). Parties can upload documents to their PDA (iPhone, Google apps, etc.) to submit to parties. Parties also have the ability to retrieve, copy, and scan original paper-based documents and upload them into the portal 10 on demand. For example, if a party has a paper document and needs to sign the document and get the document back to another party quickly, the party can use his PDA, take a picture of each page of the document, upload the document into the portal, Signing room, etc., and submit the document to the recipient for review and signature.

In step 220 the document(s) to be e-signed are received by the portal 10 from the Submitter 12.

In step 222 the portal 10 notifies the Recipient(s) 14 accordingly and routes the document(s) to the Recipient(s) 14 which may include non-signing parties. This routing may be done such that the Recipient 14 can simply be sent an e-mail such that the Recipient 14 can click on a hypertext link therein that takes the Recipient 14 to an e-signing room where he or she can access the document and see any relevant instructions (e.g., where to sign and initial, a greeting message, etc.). Alternatively, the portal 10 can prompt the Recipient 14 to download the document. Step 222 can be performed, e.g., by the interfacing module 7 of FIG. 1.

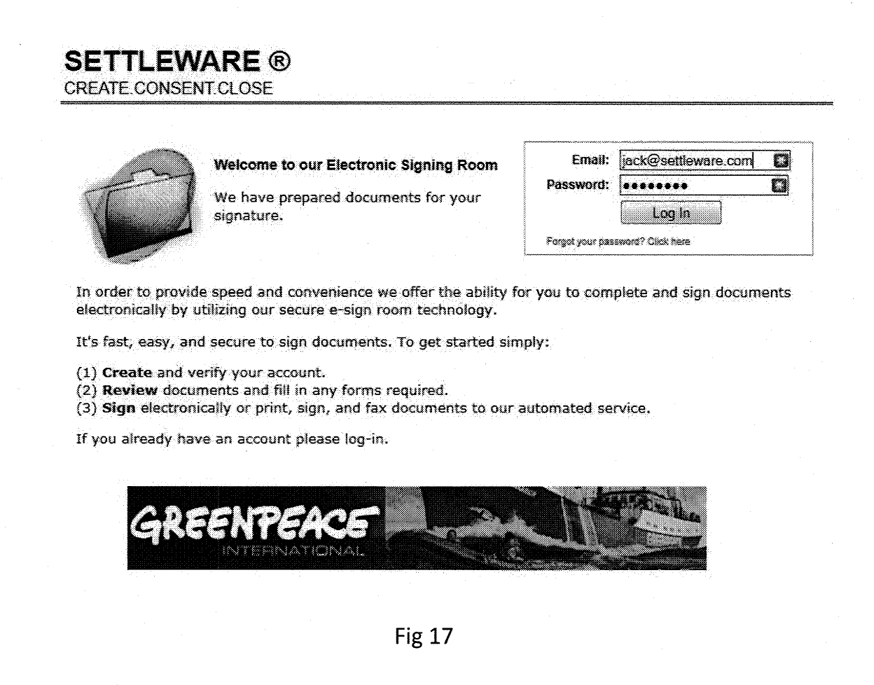

Thus, in one aspect, the parties can use the hypertext links they received to enter the secure electronic signing room, where they may each read the document and then apply an electronic signature. See FIG. 17, which shows a screen shot of the e-signing room. Each party accessing the e-signing room can be prompted to (a) create and verify his or her account, (b) review the documents and fill in any forms required, and (c) sign electronically, or print/sign/fax documents to the portal. The party can log into the e-signing room if he or she already has an account, or can register to quickly be logged in.

In step 224 the portal 10 receives the e-signed document from the Recipient(s) 14 after the Recipient(s) have authenticated identity, reviewed, and electronically signed the document(s).

In step 226 the portal 10 transmits the e-signed document(s) to the Submitter 12 for e-signature by the Submitter 12 (if applicable). In step 228 the portal 10 receives the e-signed document from the Submitter 12 after the Submitter e-signs the document (if applicable). In step 230 the portal 10 merges all the signatures into one document (if applicable). Steps 224-226 can be performed, e.g., by the receiving module 8 of FIG. 1.

In step 232 the portal 10 automatically confirms completion of all signatures and delivers copies of the originally signed document(s) to all parties to the transaction or appropriate non-parties, including non-signers. Step 232 can be performed, e.g., by the confirmation module 9 of FIG. 1.

In step 234 the transaction is closed.

During the above-noted process all parties of the transaction can be provided access to the portal to check on status and the like. Status updates can be provided in real-time or near real-time, along with display of instructions and activity. Security measures are implemented as well.

FIG. 3 shows another example method 300 of the invention. In step 302 the portal 10 accepts a log-on from the Consumer or Submitter 12, or automatically registers the Consumer or Submitter 12, even if “registration” is limited to using only the information supplied by the Consumer or Submitter 12 (such as on the signature request form shown in FIG. 18). In step 304 (optional) the portal 10 prompts the Submitter 12 for payment in exchange for accessing the services provided by the portal 10, and processes the payment information. See, e.g., the screen shots of FIG. 8 or FIG. 18, in which the Submitter 12 is prompted for his cardholder information so that secure payment can be effected.

Payment methods could include electronic funds transfer, credit card, checking, ACH, and the like, and parties can even scan a copy of a check and deposit funds directly, remotely into a recipient's account. For example, if a party does not have a credit card but desires to pay for this service by check, the party can write a check (paper), sign, and put the recipient's bank account number on the back, and endorse the check over to the recipient, and the funds are then automatically deposited into the receiving party's account.

In step 306 the portal 10 receives a document(s) uploaded by the Submitter 12, as well as e-mail addresses or the like provided by the Submitter 12 designating various parties or non-parties to the transaction (such as Recipient 14).

Parties (Submitters/Receivers/vendors) can upload document(s) via the portal 10 and/or mobile PDA, or any other suitable process (such as set top device, etc.). Parties can upload electronic files, or documents, to their PDA (iPhone, Google apps, etc.) to submit to parties. Parties also have the ability to retrieve, copy, and scan original paper-based documents and upload them into the portal 10 on demand. For example, if a party has a paper document and needs to sign the document and get the document back to another party quickly, the party can use his PDA, take a picture of each page of the document, upload the document into the portal, Signing room, etc., and submit the document to the recipient for review and signature. A mobile application can be built on, e.g., an iPhone, or via Google or Verizon, etc. for uploading electronic files/documents or to scan/capture original paper by using the Mobile/Portal device and executing a transaction (or for check payments).

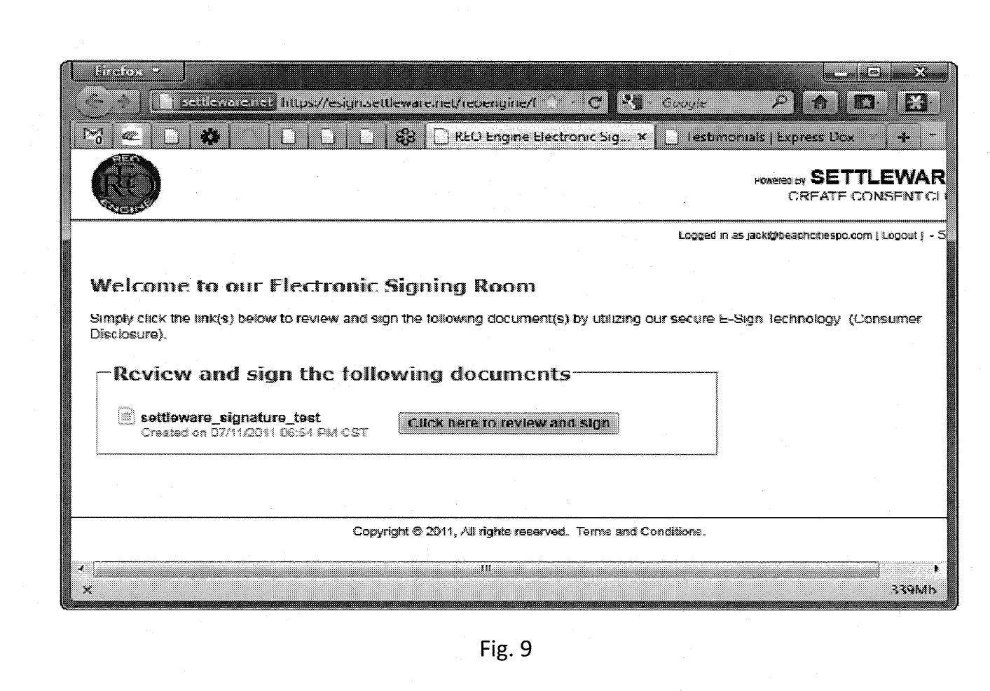

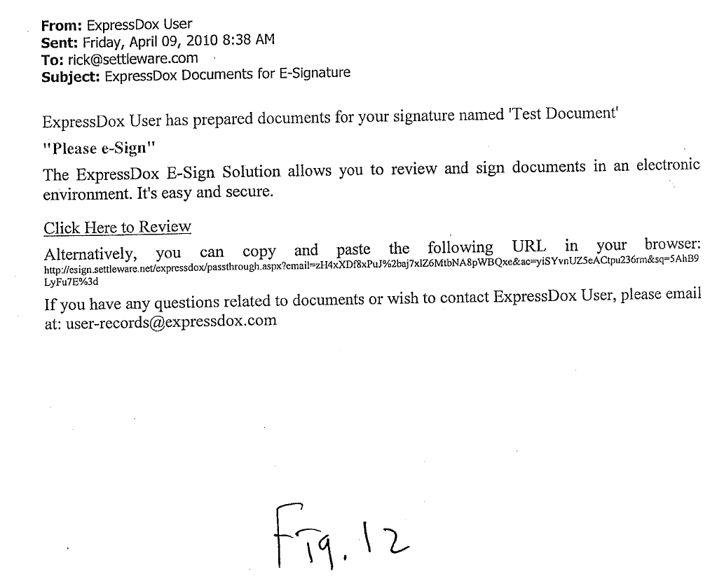

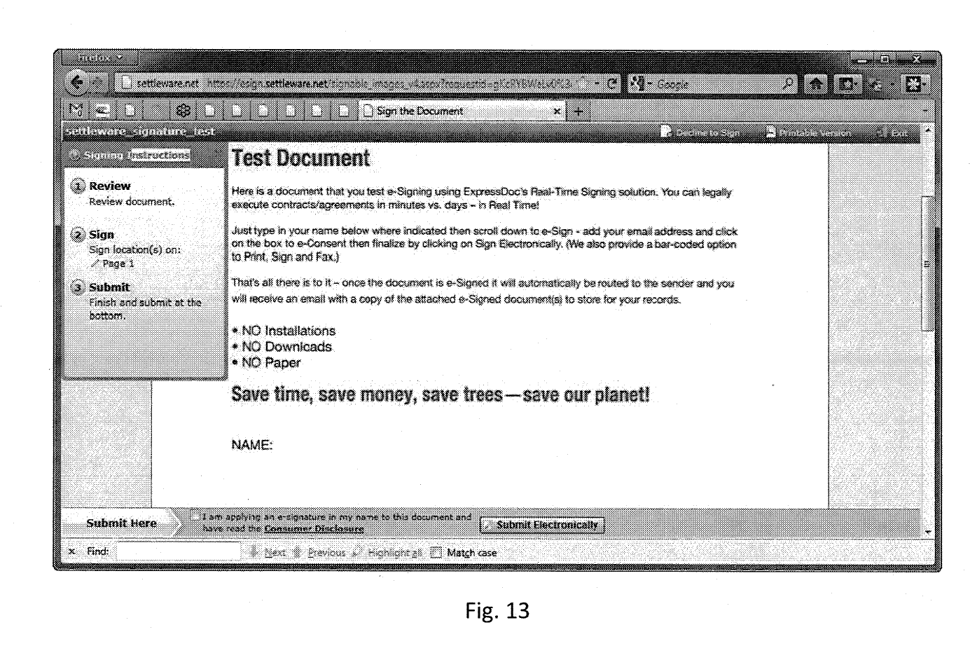

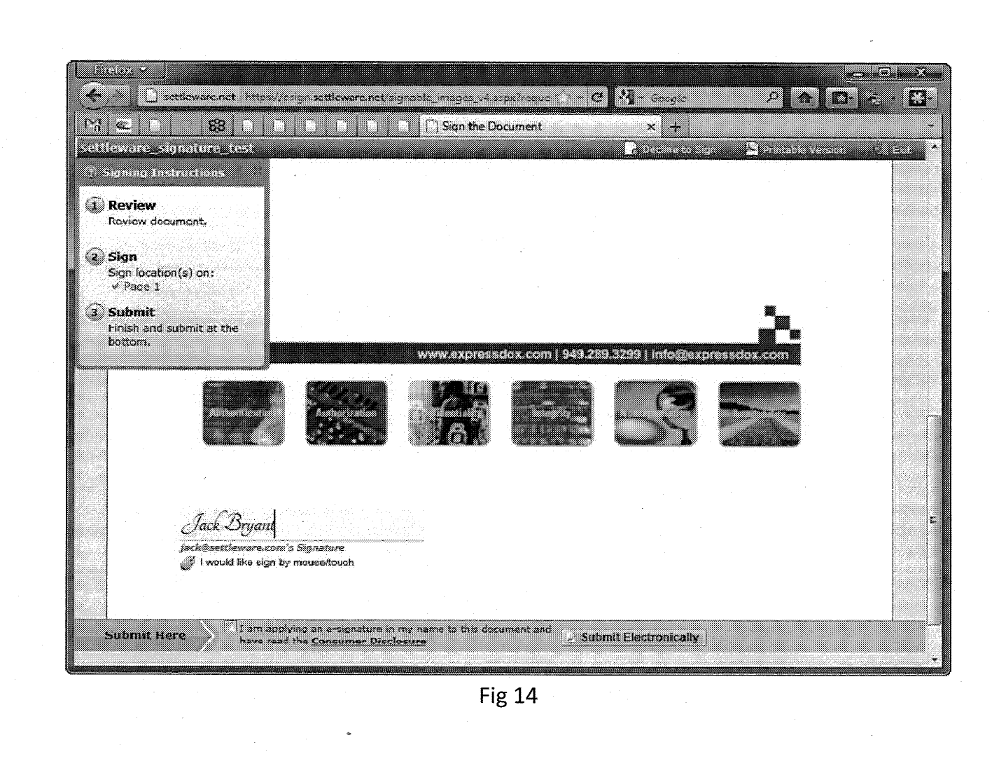

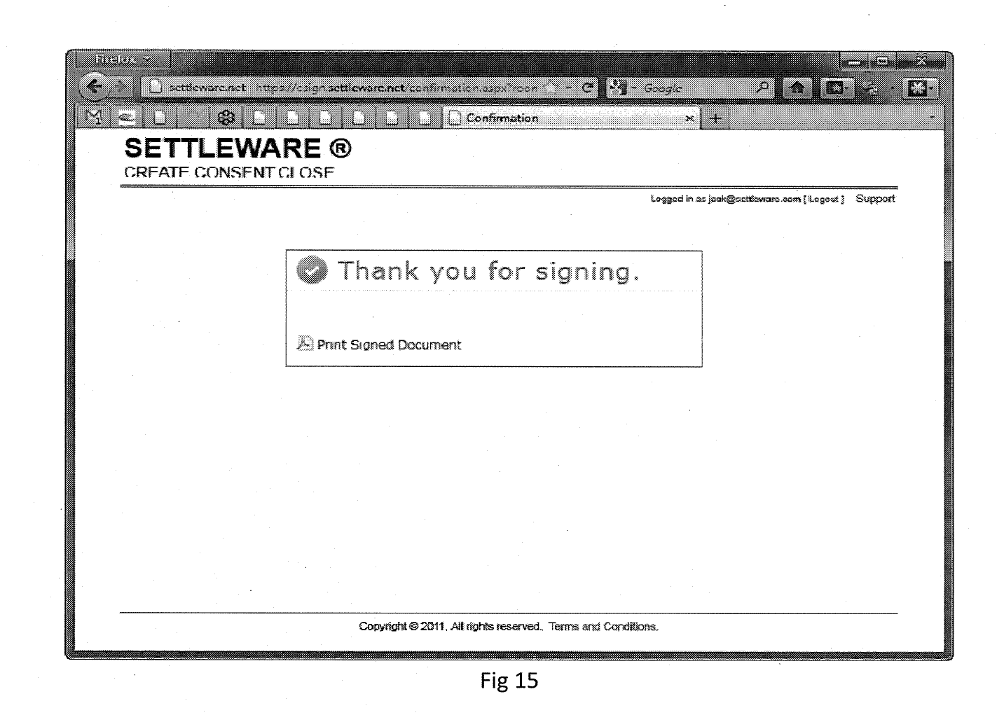

In step 308 the portal 10 generates an email to the Recipient(s) 14 (see, e.g., FIG. 12), which may include the document(s) to be e-signed (or a hypertext link pointing thereto) along with an introductory note from the Submitter 12 greeting the Recipient 14 and inviting the Recipient to e-sign the document(s). For example: “Hi John! This is Sam. These are the documents we discussed over the telephone, for your signature. Please execute the documents and return them to me using the system. Thank you.” See, e.g., FIG. 9 or 17 for an example of an “Electronic Signing Room” that the Recipient might see; FIGS. 13 and 14 for example screen shots showing the party how and where to sign; and FIG. 15 for an example screen shot thanking the party for signing and providing the party with the option to print the signed document.

In more detail, in FIG. 13, for example, the signing party is instructed where to type in his name and is then instructed to scroll down the screen (FIG. 14) to e-sign by adding his email address and then clicking on the “Sign Electronically” box. The signing party also checks a box confirming that, according to his understanding, he is applying a legally binding e-signature in his name to the document. In FIG. 15, as noted above, the signing party is thanked for signing.

Parties, recipients, etc. may need (or be requested) to verify/witness identity before they can open and review the document(s) by electronic means and/or independent third party person-to-person electronic, digital, webcam, video stream, etc. meeting (audio/visual) that can be recorded and stored for future proof and/or validation.

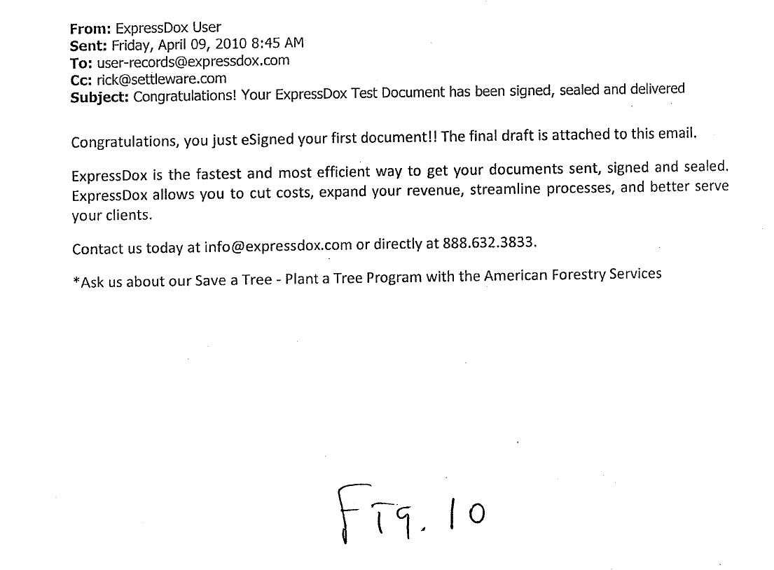

In step 310 the portal 10 receives an e-mail including the e-signed/tamper-sealed documents from the Recipient's terminal after the recipient 14 reviewed and e-signed the document(s). (Alternatively, the Recipient may upload the e-signed document(s) to the portal 10.) The portal 10 may confirm with the Recipient by e-mailing a confirmation to the Recipient confirming that the document was e-signed (see, e.g., FIG. 10). In step 312 the portal 10 generates an e-mail to the Submitter 12 that includes the e-signed document(s) and any note from the Recipient 14. In step 314 the portal 10 receives via e-mail the document(s) from the Submitter 12 after the Submitter 12 has opened, reviewed, and e-signed the documents. In step 316 the portal 10 transmits confirmation to all parties or non-parties including copies of the signed document(s).

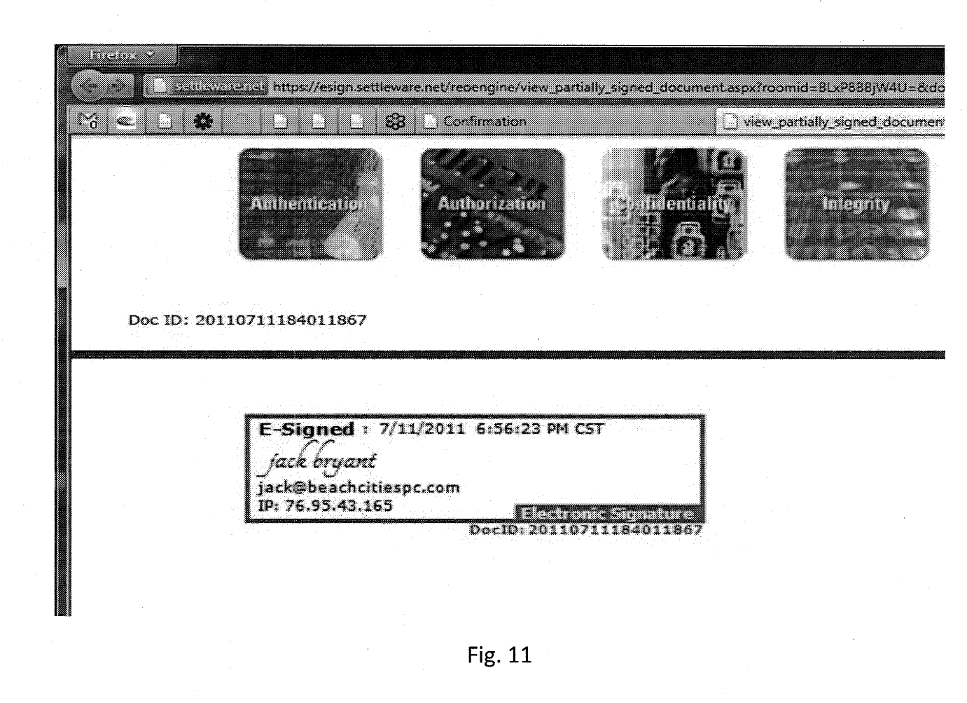

An example of an e-signature is shown in FIG. 11, which shows that “C. Richard Triola” e-signed a document on Apr. 9, 2010 at 10:45:25 AM CST. The e-signature can therefore show, for example, the signor's name and a time stamp (date and time) that he e-signed the document, along with the e-signor's email address and IP address. This e-signature can be shown on each page of the document.

All persons with permission are able to track the status, see the transaction history, etc., via step 318. For example, the portal 10 can record all document activity in an electronic journal, sometimes referred to as a transaction log. Thus, an archived audit trail or an audit journal can be preserved in the event that any electronic transaction should come under challenge. The integrity of this system can be further extended by archiving the transactions and transaction log on “write-once” mediums that are tamper resistant.

Another way to authenticate a signature according to the present invention is for the portal 10 to send a security e-mail to a signing party's email address after the portal 10 receives the signed document from the signing party. The security e-mail contains a hyperlink, for example, asking the signing party to follow the hyperlink and confirm that the signing party in fact signed the document. In this way, it can be confirmed that the person who accessed the e-mail account is the person who signed the document.

Another way to authenticate a signature according to the present invention is for the portal 10 to send an e-mail to a signing party, or otherwise prompt the signing party, asking the signing party to answer one or more security questions. These security questions will be questions asking the signing party to, for example, identify his or her home town, or mother's maiden name, or the name of his or her first pet, etc. The portal 10 will then cross check these answers against the answers the party provided when registering, or against the answers that the submitting party provided to the portal 10. In this way, authentication can be performed.

The present invention can provide signing or non-signing parties with access to the system or portal 10. This can be done in a number of different ways, such as, e.g., through the use of security keys. U.S. Pat. No. 7,127,406, hereby incorporated by reference, provides an example of security key access to a system.

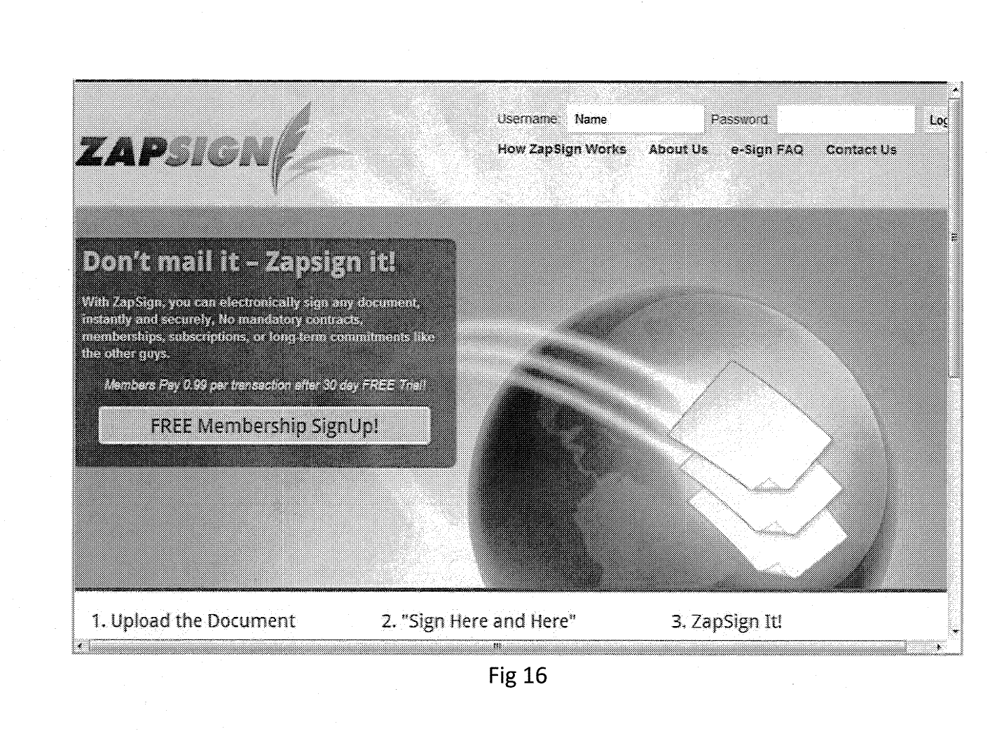

FIGS. 16-18 are screen shots showing aspects of the present invention that can be implemented with the above embodiments. Of course, these are only examples, and are not meant to be limiting. In Step One of FIG. 16, a party or person is prompted by the portal 10 to upload a document for e-signature. Here, the party is provided with a secure electronic signing request form (FIG. 18 shows an example) so that the party can create a signature request. The signature request form prompts the party for a File Name, along with the party's name and e-mail address. The signature request form also prompts the party for the email addresses of all of the people who are required to sign the document(s), as well as the email addresses of any people who will not be signing the document but who should receive copies of the signed document.

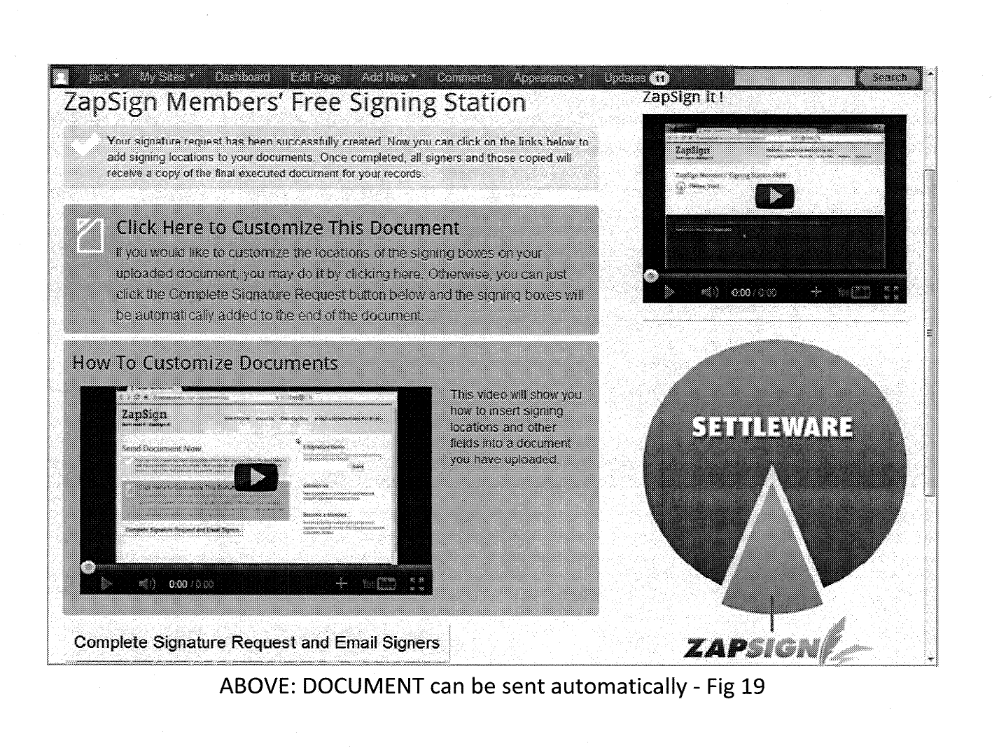

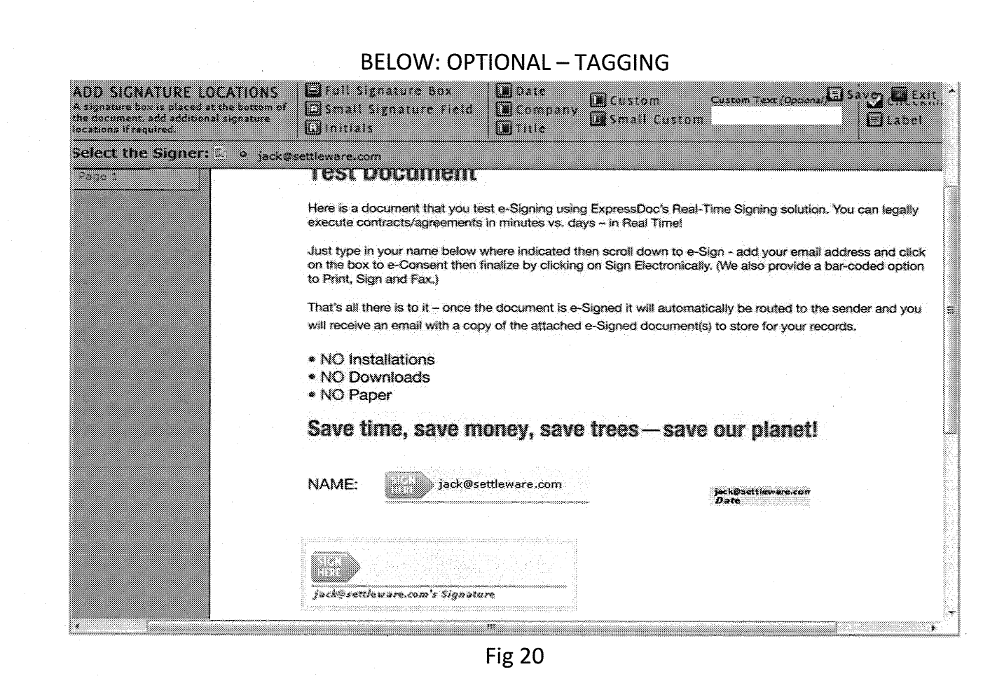

The party will also be prompted to upload the document(s) for signature, and will be afforded the opportunity to send a message to the people who will be receiving the document. (See FIG. 19, which is an example screen shot after a document has been uploaded for signature.) It is noted that before uploading the document for signature, the party can optionally be provided with drop-and-drag or “tagging” capability, i.e., the capability to drop-and-drag various fields such as party name, company name, title of signor, etc. into the document for completion by the signor. (See, e.g., the screen shot of FIG. 20.) Later, when the signor uploads the e-signed document, the portal 10 can check that all of the drop-and-drag fields have been completed by the signor, and can notify the signor if any fields were left blank such that the signor is required to fill them in before the portal 10 accepts the document as being properly and fully e-signed. Thus, the drop-and-drag fields can become mandatory fields for completion by the signor, and the e-signed document can come back 100% compliant.

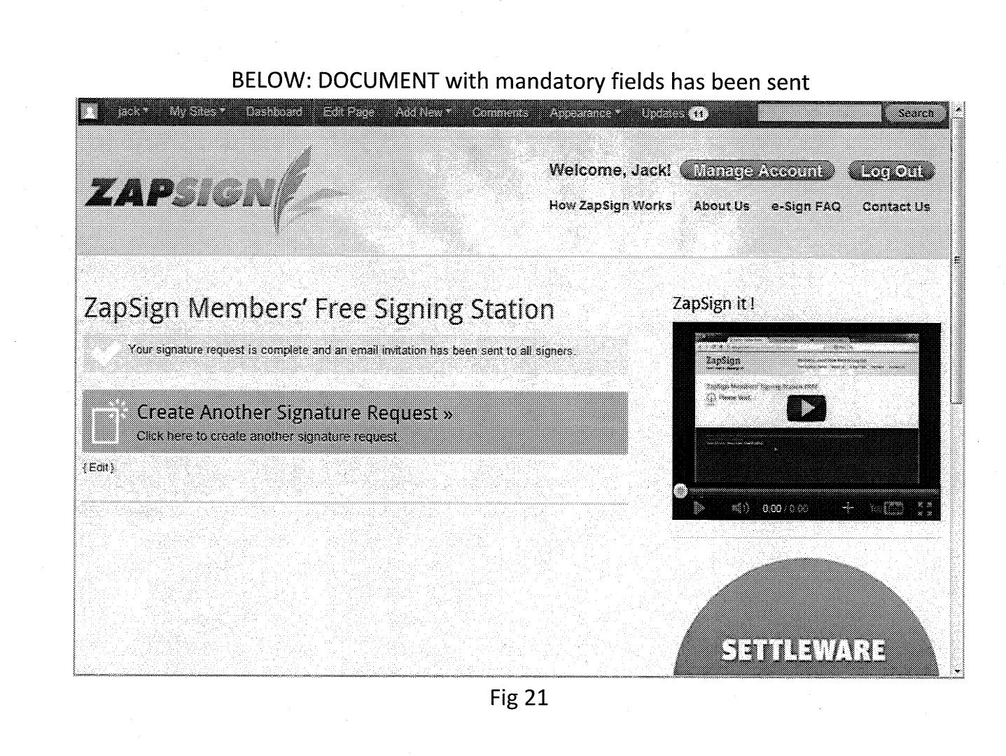

The party can also be prompted to fill in his or her credit card information so that the transaction can be paid for. Once this is done, the portal 10 sends e-mail messages to the other parties who need to sign the document or who should be cc'd. The e-mail messages will contain links to an online signing room. (See FIG. 21, which is a screen shot showing that a document with mandatory fields has been sent.)

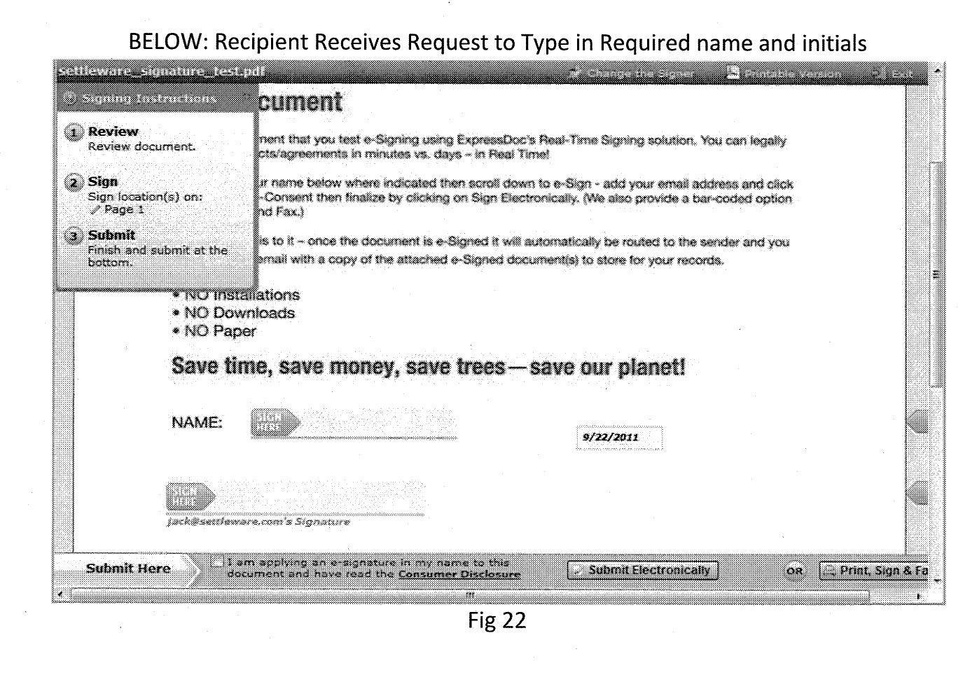

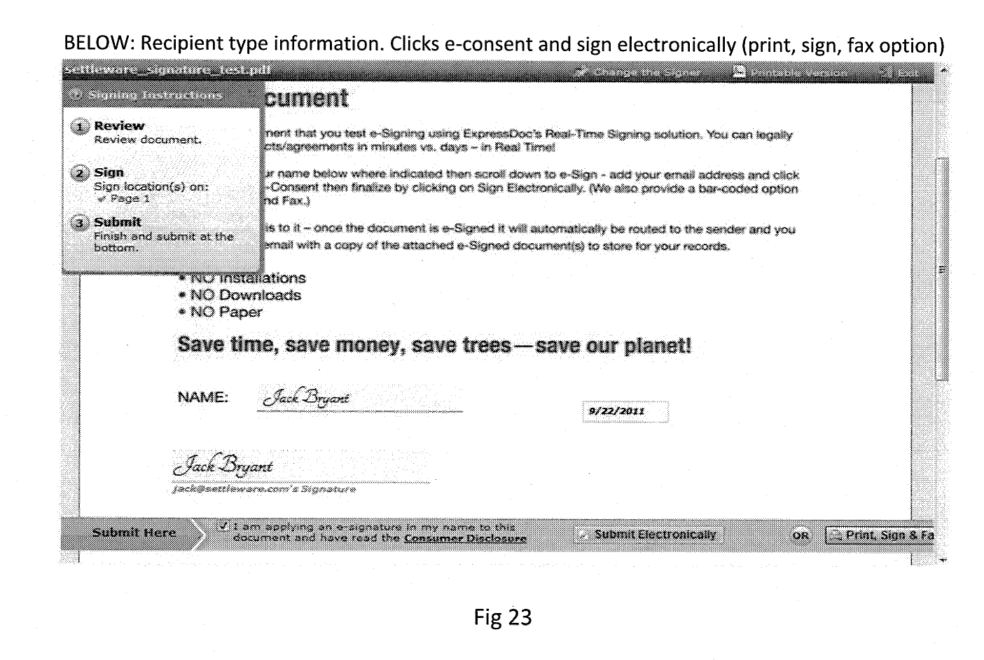

In Step Two, the parties will use the links they received to enter the secure electronic signing room, where they may each read the document and then apply an electronic signature. See FIG. 17, which shows a screen shot of the e-signing room (or see FIG. 22). Each party accessing the e-signing room can be prompted to (a) create and verify his or her account, (b) review the documents and fill in any forms required, and (c) sign electronically, or print/sign/fax documents to the portal. (See the example screen shot of FIG. 23.) The party can log into the e-signing room if he or she already has an account, or can register to be logged in.

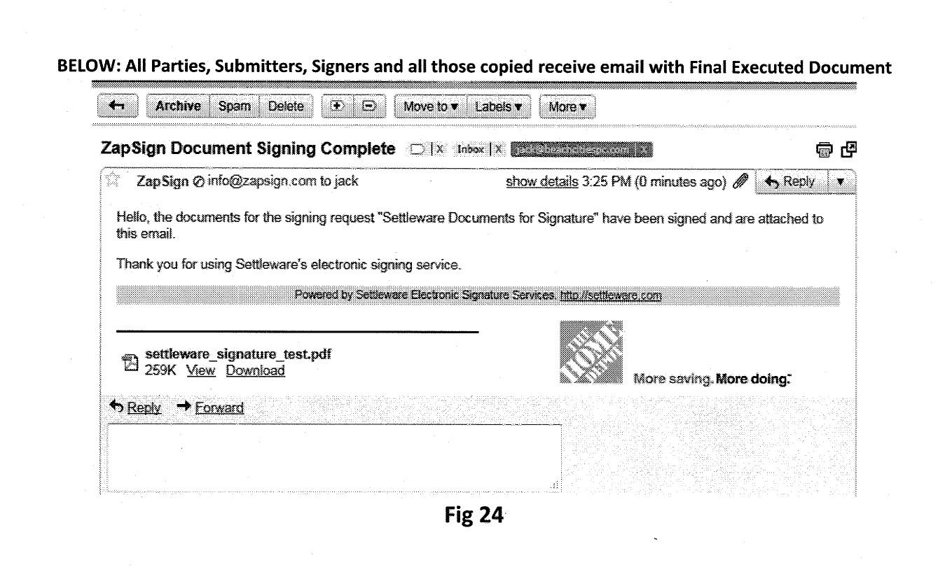

In Step Three, once everyone has applied their signatures to the document, all signers can receive email messages containing links they can click on to download the complete, signed copies of the documents. (See the example screen shot of FIG. 24.) By virtue of these features, contracts can be securely signed and returned in minutes from anywhere in the world.

The present invention can also act as a fundraising vehicle such that the provider and customers can promote various charities by placing banner ads on the screens (see, e.g., the example banner ads on FIGS. 16 and 17) and partnering with various corporations and other entities. For example, the corporations or other entities can be permitted to use the system of the present invention internally and a banner ad can be displayed announcing that a portion of the proceeds are going to the specific charity in exchange for the ad space. In another aspect, charities can be chosen from drop-down menus for selection.

The present invention can also provide access memberships to parties who wish to become regular customers of the provider of the system, wherein the provider offers memberships with discounted pricing or for free and offer benefits for membership.

The following are further example aspects of the invention.

### Digital Authentication/Validation:

Electronic implementation, transmission, presentation, validation, authentication, identification, recordation, archiving of documentation requiring a ‘face to face’ meeting, conducted via electronic means that may include an electronic identity authentication mechanism, and an electronic means of communication. An electronic meeting conducted via electronic audio and visualization capture of parties, identify validation, authentication, recording and storage, and the like
An electronic delivery mechanism that provides for all parties to receive, view, sign, execute, edit, authenticate, authorize, register, perform secure identity authentication ceremonies or acts, attest, witness, acknowledge, certify, record, store and transfer, or deposit electronic funds, charge or pay for services on demand over the INTERNET.
Provide electronic delivery of documents that can be presented for parties to view, sign, notarize, authenticate, execute, and return via electronic transmission.
Provides for tamper evident audit journals, validation, authentication.

The present invention, by virtue of its features, provides the ability for someone “on the fly” to upload a document(s), submit to a recipient(s) for signature, and accomplish a secure, signed agreement, all through a portal/browser whether the submitter has an account with the portal or not. The agreement can be electronically signed by all the parties, witnessed, notarized (e.g., virtual notary, e-notarization), etc., using verification techniques including electronic, fingerprints, retina scan, video certification (e.g., web cams), etc. These can be done at any time from anywhere using the techniques taught herein. One or multiple documents can be uploaded for e-signature, and initials can be requested, or addresses and the like, using fillable forms. Each signing party can acknowledge that he or she consents and that his or her signature is legally binding. If the signing party does not input all the requested information, the signing party can be prevented from sending the document back. Printing and faxing of the document can be accomplished as well. A “print-sign-fax” feature enables a person to print, sign, and fax a document, and the faxed document to be converted to an electronic document, after which the documents can be merged.

The present invention, by virtue of its features, can handle real-time or near real-time signature requests. A Submitter's customers need only an e-mail address and a browser to sign documents. Signature stamps are created when the Submitter sets up an account, and a fully legal alternative to pen-and-ink can be provided. When the Submitter is finished, he can print or save his signed copy. Accordingly, among the features disclosed herein, the contract process can be automated. The Submitter can be prompted by the system for the email addresses of the Recipient(s) and for uploading of the documents. Non-signers can be carbon copied, and interactive HTML forms can be sent, such that multiple signatures can be gathered on single documents.

The system can deliver an e-mail to the signers with a link to an encrypted web site where they will be taken through the signing process. The system provides the signers with the option to electronically sign the document or print, sign, and fax the document back into an automated fax server. In this way, documents can be legally signed in perhaps seconds or minutes rather than days. The system can track the entire process and allow the parties to so track the process, such that, for example, the parties can know whether the signer clicked on the link inside the email, signed the document, or printed the document to sign and fax in (“print-sign-fax”). The parties with access can see the status of each signature request. If there is no quick response to a signing request (e.g., after a predetermined period of time), an automatic reminder can be sent to the client by the system. When the document does get opened, an alert can be sent to the originator notifying them that the agreement is being viewed. Then, any delay in signing can be a trigger to the relevant party to follow up with the prospect. The system can store the contract, audit trail, or audit journal, and transaction history, and can store the contracts online for as long as the parties wish.

The system allows files to be sent securely using encryption and other techniques, and allows users to exchange forms or large files (or files of any size). Such documents may include but are not limited to sales proposals, invoices, statements, corporate documents, images, interactive web forms, loan or mortgage agreements, sales contracts, insurance documents, human resources documents, documents for the purchase or sale of personal or real property, bail bond documents, or other files.

The present invention includes an electronic e-Notary solution. The notary service verifies and validates the origin and integrity of a document or receipt, certifying the information with a state/jurisdiction approved electronic notary seal held by the designated notary. Furthermore, the present invention can use “trusted time services” to time-stamp these critical events. The system may digitally validate/authenticate in Real-Time that a Notary is licensed and current with government agencies such as Secretary of State prior to having access to system. For example, the Notary logs into the system with a unique ID and password, the system automatically pings International, National, State and/or Local agency and/or Registry to make certain with respect to the Notary logging into the system that their license has not been revoked and is in good standing. If the license/certification has been revoked then the system will deny access and thereby potentially avoid fraudulent activity and/or transactions.

The present invention can set up a relationship between clients by pre-registering parties (e.g., even before any transaction) so that the pre-registered parties are easily identified and/or authenticated later when it comes time to conduct a transaction. In this way, the clients can easily conduct all future transactions.

Parties that are pre-registered or registered can be given different capabilities. For example, a notary that is pre-registered or registered can be given the functions of a notary, such that the notary can then edit the notary block on a document (“This person appeared before me on May 5, 2011.”). In this way, special permission and roles can be granted to various parties.

The present invention, by virtue of its features, provides:
tracking when files have been received and requesting return receipts;
password encryption and firewall navigation;
online delivery and completion of web forms;
ability for users to manage their account and add/remove participants;
transaction history and the ability to retrieve previously signed documents;
multiple party submission and signing.

By virtue of the features of the present invention, productivity of the parties to an agreement or transaction can be improved, document signing processes can be streamlined, and cost can be reduced. The present invention can provide a simple and cost efficient solution and provide a web-based solution for getting documents signed. A paperless environment can be created using electronic signatures for contracts and documents.

### Example Implementation

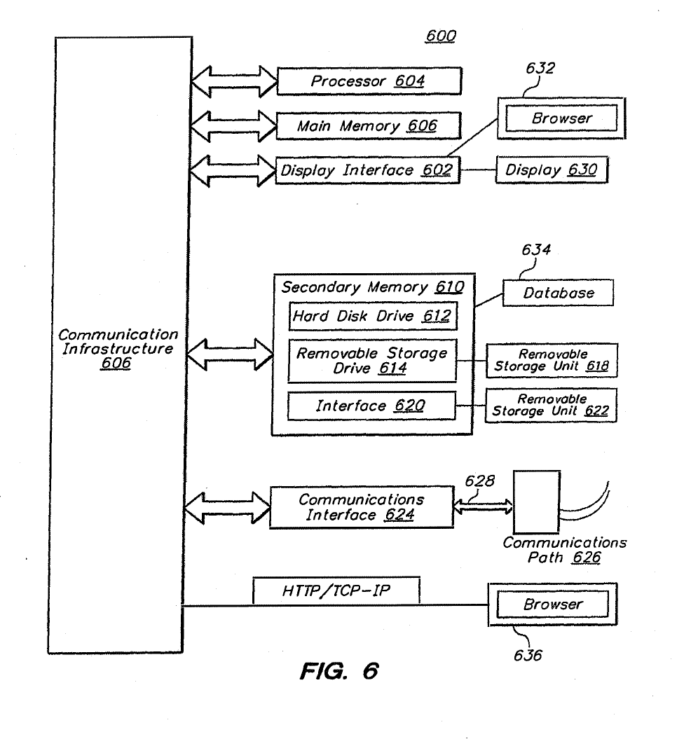

The present invention or any part(s) or function(s) thereof, including but not limited to portal 10 and end user terminals 12, 14, . . . , N, may be implemented using hardware, software, or a combination thereof, and may be implemented in one or more computer systems or other processing systems. Useful machines for performing some or all of the operations of the present invention include digital computers or similar devices. In fact, in one embodiment, the present invention is directed towards one or more computer systems equipped to carry out the functions described herein. An example of such computer system 600 is shown in FIG. 6.

The computer system 600 includes at least one processor 604. The processor 604 is connected to a communication infrastructure 606 (e.g., a communications bus or a network), which is in communication with, inter alia, a browser 636 connected to an internet or intranet. Although various software embodiments are described herein in terms of this exemplary computer system 600, after reading this description, it will become apparent to a person skilled in the relevant art(s) how to implement the invention using other computer systems and/or architectures.

The computer system 600 also includes a display interface 602 that forwards graphics, text, and other data from the communication infrastructure 606 (or from a frame buffer (not shown)) for display on a display unit 630 or on a browser 632 connected to an intranet or internet. The computer system 600 also includes a main memory 608, which preferably is a random access memory (RAM), and may also include a secondary memory 610. The secondary memory 610 may include, for example, a hard disk drive 612 and/or a removable storage drive 614 (e.g., a floppy disk drive, an optical disk drive, and the like). The removable storage drive 614 reads from and/or writes to a removable storage unit 618 in a well-known manner. The removable storage unit 618 may be, for example, a floppy disk, an optical disk, and the like, which is written to and read by the removable storage drive 614. As will be appreciated, the removable storage unit 618 includes a computer-usable storage medium having stored therein computer software and/or data.

In alternative embodiments, the secondary memory 610 may include other similar devices for allowing computer programs or other instructions to be loaded into the computer system 600. Such devices may include a removable storage unit 622 and an interface 620 (e.g., a program cartridge); a removable memory chip, and an associated memory socket; and other removable storage units 622 and interfaces 620 that allow software and data to be transferred from the removable storage unit 622 to the computer system 600.

The computer system 600 may also include a communications interface 624, which allows software and data to be transferred between the computer system 600 and external devices (not shown). Examples of the communications interface 624 may include a modem, a network interface (e.g., an Ethernet card), a communications port, a Personal Computer Memory Card International Association (“PCMCIA”) interface, and the like. Software and data transferred via the communications interface 624 are in the form of signals 628, which may be electronic, electromagnetic, optical or another type of signal that is capable of being received by the communications interface 624. These signals 628 are provided to the communications interface 624 via a communications path 626 (e.g., a channel). The communications path 626 carries the signals 628 and may be implemented using wire or cable, fiber optics, a telephone line, a cellular link, a radio-frequency (“RF”) link, or the like.

As used herein, the phrases “computer program medium” and “computer usable medium” may be used to generally refer to a removable storage unit 618 used with the removable-storage drive 614, a hard disk installed in the hard disk drive 612, or the signals 628, for example. These computer program products provide software to the computer system 600. The present invention may be implemented or embodied as one or more of such computer program products.

Computer programs (also referred to as computer control logic) are stored in the main memory 608 and/or the secondary memory 610. The computer programs may also be received via the communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the present invention is implemented using software, the software may be stored in a computer program product and loaded into the computer system 600 using the removable-storage drive 614, the hard drive 612, or the communications interface 624. The control logic (software), when executed by the processor 604, causes the processor 604 to perform the functions of the present invention as described herein. In another embodiment, the present invention is implemented primarily in hardware using, for example, hardware components such as application-specific integrated circuits (“ASICs”). Implementation of such a hardware arrangement so as to perform the functions described herein will be apparent to persons skilled in the relevant art(s). In yet another embodiment, the present invention is implemented using a combination of both hardware and software. Computer modules may carry out various features of the present invention.

Accordingly, pursuant to various implementations of the present invention, from a hardware standpoint, a CPU typically comprises one or more components, e.g., one or more microprocessors, for performing the arithmetic and/or logical operations required for program execution, and storage media, such as one or more disk drives or memory cards for program and data storage, and a RAM, for temporary data and program instruction storage. From a software standpoint, a CPU typically includes software which is resident on a storage media which, when executed, instructs the CPU in performing transmission and reception functions. The CPU software may run on an operating system stored on the storage media, such as, for example, UNIX or Windows (e.g., NT, XP, Vista), Linux, and the like, and can comply with various protocols such as the Ethernet, ATM, TCP/IP protocols and/or other connection or connectionless protocols. CPUs can run different operating systems, and can contain different types of software, each type devoted to a different function, such as handling and managing data/information from a particular source, or transforming data/information from one format into another format. Therefore, it should be clear that the embodiments described herein are not to be construed as being limited for use with any particular type of server computer, and that any other suitable type of device for facilitating the exchange and storage of information may be used instead.

Software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The present invention may be implemented on, e.g., a “machine accessible medium” or “machine readable medium,” which shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. Finally, embodiments of the present invention may be implemented on a “computer-readable medium,” where the term “computer-readable medium” may include a computer-readable signal medium and a computer-readable storage medium. A computer program product is directed to a computer-readable storage medium.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

It should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A method implemented on a computer having a processor and a memory coupled to said processor for performing delivery and execution of documents, said method comprising the steps of:
providing an online signature request form requesting a submitting party to provide information identifying each signing party to a transaction, wherein the information includes names and e-mail addresses of each signing party;
automatically and instantaneously identifying each signing party using the information received from the submitting party via the online signature request form;
receiving a document from a submitting party for electronic signature in a transaction;
providing each signing party with access to the document for electronic signature;
receiving an electronically signed document from each signing party; and
confirming completion of each electronic signature to each party,
wherein the method is entirely computer-automated such that all of the steps of the method are performed using said processor.

2. A system implemented on a computer having a processor and a memory coupled to said processor for performing delivery and execution of documents, said system comprising:
an initiation module, for causing the processor to initiate a transaction, request a submitting party to provide information identifying each signing party to a transaction and any non-signing party to be copied on the transaction, and receive at least one document from the submitting party for electronic signature, wherein the information includes names and e-mail addresses of each signing and any non-signing party;
an identification and authentication module, for causing the processor to automatically and instantaneously identify each signing party and any non-signing party using the information received from the submitting party;
an interface module, for causing the processor to provide an interface accessible by each party to effect the electronic signing, including providing each signing party with access to the at least one document for electronic signature along with instructions for electronically signing the document;
a receiving module, for causing the processor to receive the electronically signed document from each party; and
a confirmation module, for causing the processor to confirm completion of each electronic signature to each party.

3. A non-transitory computer-readable storage medium storing a program, which, when executed by a computer, performs a method for delivery and execution of documents, said method comprising the steps of:
opening a transaction;
receiving at least one document from a submitter for electronic signature;
automatically and instantaneously identifying and registering or authenticating each party to the transaction based on information supplied by a submitter, and providing each party with access to the at least one document for electronic signature along with instructions for electronically signing the document;
providing an interface accessible by each party to effect the electronic signing;
receiving the electronically signed document from each party; and
confirming completion of each electronic signature.

4. A method implemented on a computer having a processor and a memory coupled to said processor for delivery and execution of documents, said method comprising the steps of:
prompting the submitter for identifying information for opening a transaction, and automatically and instantaneously registering the submitter based on the information supplied by the submitter, wherein the information includes names and e-mail addresses of the submitter and each signing party and any non-signing party;
opening the transaction;
automatically and instantaneously identifying each signing party and any non-signing party using the information received from the submitter;
receiving at least one document from the submitter for signature;
providing each signing party with access to an interface to effect the electronic signing, including providing access to the at least one document for electronic signature along with instructions for electronically signing the document;
receiving the electronically signed document from each signing party; and
confirming completion of each electronic signature and providing a copy of the electronically signed document to each party,
wherein the steps of the method are performed using said processor.

5. The method of claim 4, further comprising the step of prompting the submitter for payment for the transaction.

6. The method of claim 4, further comprising the step of providing a greeting message from the submitter to each party to the transaction.

7. The method of claim 4, further comprising the step of providing a received message from a party to the other parties.

8. The method of claim 4, wherein the identification of each party to the transaction is determined by information provided by the submitter.

9. The method of claim 8, wherein the information provided by the submitter includes a name and an e-mail address of each party to the transaction.

10. The method of claim 4, wherein the instructions provided to each party includes at least one of text, audio, and video instructions.

11. The method of claim 4, wherein the authenticating of a party to the transaction includes receiving a password from the submitter, requesting the party to the transaction to provide the password, and confirming that the password received from the party is correct.

12. The method of claim 4, wherein the step of providing each party with access to the document for electronic signature includes providing each party with a hypertext link for accessing the document.

13. The method of claim 4, wherein the step of providing each party with access to the document for electronic signature includes providing each party with a file containing the document for downloading.

14. The method of claim 4, further comprising the step of transmitting the electronically signed document received from each party to the submitter for electronic signature by the submitter.

15. The method of claim 4, further comprising the step of merging the electronically signed documents received from each party into a single document showing each electronic signature.

16. The method of claim 4, further comprising the step of providing a copy of the electronically signed document to each party.

17. The method of claim 4, further comprising the step of providing access to the at least one document to a person who is not a party to the transaction.

18. The method of claim 4, further comprising the step of providing a status update of the transaction to each party to the transaction or to a person who is not a party to the transaction.

19. The method of claim 4, wherein the interface provided to each party to effect the electronic signature is an e-signing room which includes name and e-mail address fields for the party to complete, a box for the party to check certifying that the party is applying a legally binding signature in the party's name, and a tab for the party to click in order to apply the electronic signature.

20. The method of claim 4, wherein the step of confirming completion of all signatures includes showing an electronic signature box for each party, wherein the electronic signature box includes at least one of the party's name, e-mail address, IP address, and a time and date stamp.

21. The method of claim 4, further comprising the step of creating a transaction log which shows a transaction history and status of the transaction.

22. The method of claim 4, further comprising the step of transmitting a reminder to a party if an electronically signed document has not been received after a predetermined time period.

23. The method of claim 4, further comprising the step of receiving an alert once a document for electronic signature has been accessed by a party.

24. The method of claim 4, wherein the step of receiving at least one document from a submitter includes opening a document uploaded by the submitter or downloading a document emailed by the submitter.

25. The method of claim 4, wherein the step of receiving the electronically signed document from each party includes receiving includes opening a document uploaded by the party or downloading a document emailed by the party.

26. The method of claim 4, further comprising the step of routing the document to each party sequentially for electronic signature one at a time.

27. The method of claim 4, wherein the authenticating includes sending a security e-mail to a party's email address after receiving the electronically signed document from the party, wherein the security e-mail contains a hyperlink asking the signing party to follow the hyperlink and confirm that the party in fact electronically signed the document.

28. The method of claim 4, wherein the authenticating includes prompting the party to answer one or more security questions and confirming that the answers are correct.

29. The method of claim 1, further comprising the step of prompting the submitting party for payment information.

30. The system of claim 2, wherein the initiation module also causes the processor to prompt the submitting party for payment information.

31. The method of claim 1, wherein the signature request form also requests the submitting party to provide information identifying each non-signing party to be copied on the transaction, and the confirming step includes providing a copy of the electronically signed document to each non-signing party.
